(19) United States
(12) Patent Application Publication
(10) Pub. No.: US 2004/0158704 A1
(43) Pub. Date: Aug. 12, 2004

(54) Providing encrypted real time data transmissions on a network

(75) Inventors: John D. Oates, Castle Hill (AU); Alexander M. Scholte, Chatswood (AU)

Correspondence Address: SHERIDAN ROSS PC, 1560 BROADWAY, SUITE 1200, DENVER, CO, 80202

(73) Assignee: Avaya Technology Corp., Basking Ridge, NJ (US)

(21) Appl. No.: 10/366,006

(22) Filed: Feb. 12, 2003

(51) Int. Cl. H04L 9/00

(52) U.S. Cl. 713/151

(57) ABSTRACT

A method and system for providing secure network communications that are provided in a communications protocol designed to support real time (or nearly so) communications on networks such as the Internet. Encrypt/decryption parameters and techniques are determined by the network endpoints whose communications are to be encrypted. Such determinations are made in a control protocol that controls network communications in the communications protocol. The communications protocol may be the Real Time Protocol (RTP), and the control protocol may be the Real Time Control Protocol (RTCP).

### RELATED FIELD OF THE INVENTION

The present invention relates to providing encrypted communications between node (endpoints) of a communications network wherein the communications are real time (or nearly so); and in particular, for providing encryption/decryption enhancements to communications protocols for performing real time (or nearly so) network communication; and more particularly, for providing such enhancements for the Real Time Protocol (RTP) and the Real Time Control Protocol (RTCP).

### BACKGROUND

There are numerous applications where secure real time network communications are desirable, for example, voice over the Internet Protocol (commonly known as “voice over IP” or VoIP) applications, applications providing proprietary multimedia Internet presentations, “pay for view” network distributions such as sports events, and corporate teleconferencing applications. However, real time (or near real time) applications have timing constraints that are not present in other forms of network communication such as typical client-server Internet interactions, email, and short message services. In particular, real time data must arrive and be in a useful form within a narrow time window to be useful. More precisely, real time (or near real time) data, in the present context, refers to information that will become redundant, or useless after a specific interval of time has expired relative to a predetermined condition occurring. Note that the condition is dependent upon at least additional information wherein the information and the additional information form a time series of data. For example, in the case of a network communication (e.g., the Internet) carrying an audio stream, the audio data is packetized and sent to a remote listener. If for whatever reason a particular packet is excessively delayed, by the time the remote listener receives the packet the time to ‘play it out’ may have already passed. Accordingly, such a data packet is discarded. Thus, particular network protocols have been developed to facilitate real time (or nearly so) network communications. Implementation of such protocols, for packetized networks, may include features such as application data type identification for packets, sequence numbering for ordering received packets in the order they were sent, timestamping of packets so that received packets can be processed timely, and packet delivery monitoring for determining network quality of service and/or mitigating poor quality of service.

Moreover, when real time (or nearly so) network communications are also required to be secure, via, e.g., encryption techniques, there are additional burdens placed upon both the network applications requiring the secure communications, and on the network itself. For example, it is known that the security of at least some encryption techniques is reduced by repeatedly encrypting with the same encryption keys. Accordingly, for applications to provide a high assurance that network communications can not be compromised, this has typically meant that the encryption keys are repeatedly changed during a network communication session. Additionally, the standard solution for the distribution of encryption keys has been to rely on either a centralized registry of keys, or a centralized network server to ensure that all network endpoints participating in a secure communication session obtain appropriate cryptographic information, e.g., for decrypting received encrypted data. This, however, inhibits the scope of where secure communications can be provided in that: (a) some operating systems (and/or the network endpoints they service) do not have support for obtaining encryption keys from such centralized registries or network servers (which are often times third parties), and/or (b) some operating systems (and/or the network endpoints they service) may be operating independently of such registries and servers. Moreover, such centralized registries or servers are likely to require particular data formats, and processing, as well as particular encryption capabilities by the network endpoints seeking secure communications. This encryption burden adds more complexity to the applications in that, e.g., there can be additional network interfaces required to process the encryption control data. Additionally, for real time (or nearly so) applications, this additional complexity can also show up in the processes for identifying and processing data in a timely fashion. Moreover, such additional communications with key registries or servers place a greater burden on the network, particularly if the network session includes a large number of network endpoints between which the communications are to be secure. Furthermore, when information is to be communicated and processed in real time (or nearly so), such additional network communications with key registries or servers can jeopardize the value of the communications between the parties desiring such secure real time communications in that processing of communications between the parties is dependent upon one or more additional network transmissions (from such a key registry or server) being received and being received timely.

Alternatively, instead of accessing encryption keys from key registries or servers, some network applications have hard-coded encryption/decryption keys in the firmware of network endpoint devices. This reduces a real time secure application's dependence upon such encryption data provided by a third party. However, this solution substantially reduces the flexibility in the encryption techniques that can be used, and is likely to also reduce the number of network endpoints with which secure encrypted communications can be established.

Thus in both of the above prior art techniques for encrypting real time communications there are undesirable consequences that prohibit secure real time communications from being wide spread on a network such as the Internet.

An example of one pair of network communication protocols for providing support for real time (or near real time) packetized communication on a network (e.g., the Internet) is the Real Time Protocol (RTP) and its companion control protocol known as Real Time Control Protocol (RTCP). RTP and RTCP are designed to be independent of the underlying transport and network communication protocol layers as well as the operating systems of network endpoints. Accordingly, the built-in or standardized network services provided by RTP and RTCP to all applications are limited to services that enable and/or facilitate real time (or near real time) network communications. For example, the services provided include (for RTP data packets) are those described hereinabove, namely, payload type identification, sequence numbering, timestamping, and delivery monitoring. Application data is communicated between two or more cooperating network endpoints in RTP while RTCP is primarily used: (a) to monitor such RTP communications for, e.g., quality of service, and/or statistics on lost data packets, and (b) to convey resulting monitored information about the RTP communications to the participants (or their corresponding network endpoints) in an on-going RTP network communication session.

Although RTP and RTCP have built in features to support encrypted communications, neither RTP nor RTCP define the methods required to initialize and establish the encrypted communications sessions with the necessary keys and other parameters. Moreover, such support can require substantial additional network control transmissions by such applications, such as additional non-RTP and non-RTCP protocol transmissions for requesting for encryption keys. These additional transmissions are particularly burdensome for so called “light weight” applications that would otherwise transmit very little control data between communicating network endpoints.

Accordingly, it would be particularly desirable to incorporate the capabilities into RTP and RTCP network communications that would allow encrypted sessions to be setup so that network endpoints that can utilize these standardized and widely used protocols could more easily avail themselves of secure encrypted communications.

Definitions and Terms

A brief description of some definitions and terms used herein will now be provided.

Real Time (nearly so): A process or communication timing constraint wherein an elapsed time between the origination of an input to the process or communication and the delivery of an output by the process or communication must be provided within a predetermined time period to a designated entity while the designated entity is performing a task requiring the output to optimally perform its task. Typically, real time refers to a process or communication having a timing constraint that is sufficiently short so that it is substantially transparent to a user that the process or communication is being performed. In some cases, there may be less stringent timing constraints wherein a user is aware of a some small delay due to the process or communication; e.g., a delay of up to three seconds. In such cases, the process or communication may be denoted as “nearly real time”. Of course, when a process or communication is denoted “real time” then it is certainly also “near real time”. When a process or communication is real time or nearly real time, the terms “real time (nearly so)” and “real time or nearly so” are used herein. Additionally, the input to and/or the output from a corresponding real time or nearly so process or communication may be also denoted herein as “real time”, “nearly real time”, or “real time or nearly so” depending upon whether the corresponding process or communication is so identified.

Cypher: A cypher is an embodiment of a cryptographic technique for encrypting and decrypting data.

Diffie-Hellman: This refers to a particular public key cryptographic technique denoted by this term in the encryption art. This encryption technique is primarily used for public key exchange in conjunction with of some other private key type cryptographic system, as one skilled in the art will understand. The basis for the technique is the difficulty of calculating logs in modular arithmetic. An example follows.

If network endpoints A and B wish to establish a cryptographic key, then A sends B the number g, the modulus m, and the number h1=g^{e1} mod(m), where e1 is a large number (<m). B then sends back to A the number h2=g^{e2} mod(m).

A and B each then use the number k=g^{(e1*e2)}=h1^{e2}=h2^{e1} mod(m) as the private key. Any unauthorized communication interceptor must be able to calculate either e1 from the triple (g, m, h1), or e2 from the triple (g, m, h2). This is believed to be extremely hard for large enough values of g, and m. Further reference information can be found on the Engineering Task Force IETF website at http://www.ietf.org/rfc/rfc2631.txt this information being fully incorporated herein by reference. Moreover, additional reference information can be found in W. Diffie and M. E. Hellman, New directions in cryptography, IEEE Transactions on Information Theory 22 (1976), 644-654 which is also fully incorporated herein by reference.

RC4: This term refers to a cryptographic technique invented by Ron Rivest who is a co-inventor of the well known RSA cypher. As with the cypher RSA, RC4 is claimed as a proprietary system of RSA Security Inc, Belford, Mass., USA. RC4 is used in a number of commercial systems like Lotus Notes and secure Netscape. Note that in early 1995 a routine was published anonymously on the Internet claiming to be RC4. It was tested against a valid copy of RC4, and the tests seemed to indicate that it acted identically to the real RC4.

RTP and RTCP: The RTP and RTCP are protocols for the transmission and monitoring of real time media data using IP (Internet Protocol). The protocols define a packet format and common fields generally useful when transmitting real time media. For example the standard defines a sequence number, synchronization source identifier, synchronization time stamps and transmission timestamps. The protocols are completely specified in the article “RFC1889. RTP: A Transport Protocol for Real-Time Applications” by H. Schulzrinne, S. Casner, R. Frederick, and V. Jacobson of the Audio-Video Transport Working Group of the Engineering Task Force (IETF), this article being fully incorporated herein by reference. Further reference can be obtained on the IETF website. http://www.ietf.org/rfc/rfc1889.txt.

Key exchange type: Method by which keys used for the encryption of data can be derived by two or more parties without the transmission of the actual keys. Examples of well known key exchange algorithms include the Diffie-Hellman Key Exchange Algorithm and Buchmann-Williams Key Exchange Algorithm.

### SUMMARY

The present invention provides secure encrypted real time network communications between network endpoints, wherein the encryption control data (e.g., encryption/decryption key data) is communicated between the endpoints without a third party being required and without the encryption control data being communicated separately or independently from a control protocol being used to control and monitor the real time communications between the participating network endpoints.

In one aspect of the present invention, encryption control information is integrated into the communications protocol, RTCP so that encrypted communications in the protocol RTP can be easily provided and used by network communications on IP networks, and wherein applications requiring real time (or nearly so) secure network communications such as applications providing voice over IP (Internet Protocol), Internet broadcasts of confidential corporate information, and confidential teleconferences can be more easily developed and utilized throughout, e.g., a heterogeneous collection of communicating networks such as the Internet is. For example, in voice over IP applications the present invention can be used to encrypt and decrypt voice data packets communicated over a network such as the Internet. Additionally for applications providing, e.g., Internet broadcasts of confidential (or non-public) information (such as proprietary corporate information, or pay for view information), the present invention can be used to encrypt and decrypt multimedia presentations and thereby restrict access to such presentations.

In another aspect of the present invention, the encryption and decryption keys are determined by the network endpoints of the secure communication, and accordingly there is no need for these endpoints to access key registries or key servers on the network for obtaining encryption and decryption keys. More particularly, the present invention uses a public key encryption algorithm, such as by Diffie-Hellman (discussed in the Definitions and Terms section above), to exchange and/or derive one or more secret keys known only by the network endpoints for the secure communication. However, any other public key exchange techniques such as the Buchmann-Williams Key Exchange Algorithm as described in the reference by J. Buchmann and H. C. Willams entitled: “A Key-Exchange System Based On Imaginary Quadratic Fields”, Journal of Cryptology, 1(2):107-118, 1988, incorporated herein fully by reference, may also be used.

Once the secret keys are derived by the network endpoints for the secure communication, these endpoints use these secret keys to: (a) encrypt application data (“payloads”) of RTP packets using a first cypher at a endpoint sending such RTP packets, and (b) decrypting such payloads of RTP packets received by a second cypher at another network endpoint for the secure communications. In one embodiment, each of the first and second cyphers for encrypting may be embodiments of the RC4 cryptographic technique. However, the first and second cyphers may also be embodiments of any symmetric block cipher such as: AES (Rijndael), RC2, RC5, RC6, MARS, Twofish, Serpent, IDEA, DES, Triple DES, Blowfish, TEA, SAFER+, GOST, CAST-128, CAST-256, Square, Skipjack as one skilled in the art will understand. The choice of the cyphers may be dependent upon computational capabilities of the network endpoints and the memory requirements for caching received data packets which, e.g., may be streamed to the recipient endpoint as one skilled in the art will understand.

Other benefits and aspects of the present invention will become evident from the accompanying drawings and the detailed description hereinbelow.

### BRIEF DESCRIPTION OF THE DRAWINGS

FIG. 1 is a block diagram representation of the computational and network related components for providing secure network communications between two network endpoints (14 and 16) according to the present invention.

FIGS. 2A-2C is a flowchart representing the high level steps performed by the two network endpoints 14 and 16 (FIG. 1) when communicating securely with the RTP and RTCP protocols according to the present invention.

### DETAILED DESCRIPTION

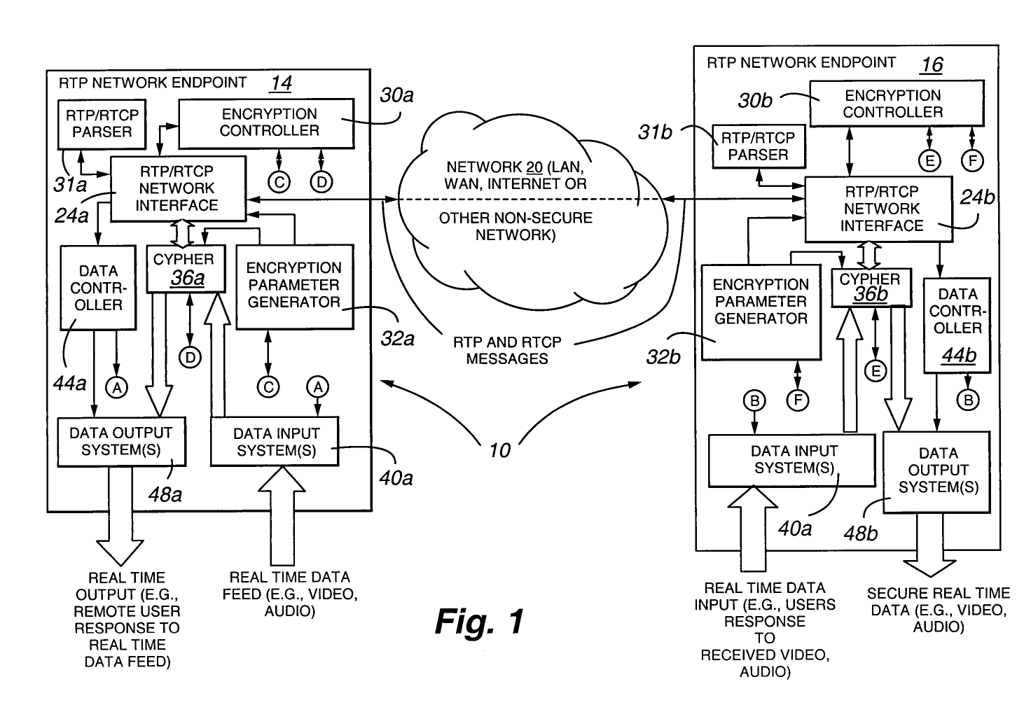

FIG. 1 shows a simple diagram of the components of the secure communication system 10 of the present invention for providing real time (or nearly so) encrypted communications. In particular, this figure illustrates the components of the secure communication system 10 wherein there are only two network endpoints 14 and 16 which desire secure communications via the network 20. In particular, FIG. 1 shows the components for secure two way communications between the endpoints 14 and 16; i.e., from endpoint 14 to endpoint 16, and responses from endpoint 16 to endpoint 14. Moreover the embodiment of FIG. 1 uses RTP as the real time (or nearly so) network transport protocol, and RTCP as the corresponding control protocol. However, it is within the scope of the present invention that substantially any number of network 20 endpoints can have secure communications established therebetween, as one skilled in the art will understand after reviewing the figures and their accompanying description. For example, for providing secure real time two way network communications between a plurality of network endpoints (e.g., for a teleconference), one designated endpoint may be designated as a hub endpoint such that each of the other endpoints establishes secure network communications with this hub endpoint and subsequently all secure network communications between the endpoints are routed through this hub endpoint. Moreover, one-way secure real time communication between network 20 endpoints is also within the scope of the invention, as one skilled in the art will recognize.

Since endpoints 14 and 16 have some components that are (or can be) substantially identical in their functionality, such substantially identical components of endpoints 14 and 16 will be described only for endpoint 14. Moreover, such components of endpoint 14 will have labels ending with an “a”, whereas comparable components for endpoint 16 will have an identical numerical portion of its label but such labels will end with a “b”. However, note that designated hub endpoints may have a somewhat different configuration as one skilled in the art will understand.

Referring now to the components of endpoint 14, there is an RTP/RTCP network interface 24a for transmitting and/or receiving RTP and RTCP data packets from the network 20, wherein this network may be, e.g., the Internet, a local area network (LAN), a wide area network (WAN), or a hybrid combination of various non-secure networks as one skilled in the art will understand. Accordingly, the RTP/RTCP network interface 24a includes substantially all the functional features of the RTP and RTCP protocols for real time (or nearly so) communications on the network 20. Thus, as one familiar with these protocols will recognize, the RTCP data packets are intermittently or periodically transmitted between all communicating network endpoints in a given real time communication session. Moreover, in addition to the RTCP data packets providing status information regarding the real time (or nearly so) data that is being communicated in RTP between the endpoints, the standards for RTCP also include the ability to extend RTCP data packets to provide additional information. In particular, RTCP data packets, known as “APP packets”, can be extended to include, e.g., encryption control information. In one embodiment, an extended APP packet example for including encryption control information is shown in TABLE A hereinbelow. The example of an APP packet data structure of TABLE A illustrates the inclusion of encryption keys (more generally, “encryption parameter data” herein) determined using Diffie-Hellman (e.g., as briefly described in the Definitions and Terms section hereinabove), and identification of the data encryption/decryption technique as RC4 (also described above). TABLE A follows:

TABLE A
(RTCP APP packet structure example)

| | Size | |
|---|---|---|
| Field Name | (bits) | Comment |
| V | 2 | RTP Version. |
| P | 1 | This field should usually be set to zero to signify no extra |
| | | padding, as specified in RFC1889. |
| SubType | 5 | Application dependent and application settable |
| Packet Type | 8 | RTCP APP packet type identifier 204 as specified in |
| (PT) | | RFC1889. |
| Length | 16 | Length of the APP packet as specified in RFC1889. |
| SSRC | 32 | Synchronization source identified for this APP packet as |
| | | specified in RFC1889. |
| Name | 32 | The four character code used to define the encryption |
| | | initiation APP Packet as specified in RFC1889, e.g., “_AV_.” |
| Sender Initiated | 1 | Set to 1 if this is a sender initiated request. Note that a |
| (SI) | | receiver's response to a sender initiated response will set this |
| | | bit to 0. |
| Type | 7 | The type of APP packet being transmitted. The values for |
| | | this field is numeric and corresponds to any one of: |
| | | (a) Initiate Encryption Request, |
| | | (b) Respond Successful Encryption request, |
| | | (c) Respond Fail Encryption Request but retry, |
| | | (d) Respond Fail Encryption do not retry. |
| Algorithm | 8 | The value specifies the encryption and decryption algorithm |
| | | to use, e.g., RC4. Values used to denote a particular |
| | | encryption algorithm are application specific. |
| Payload Type | 8 | The value that will be placed in the RTP payload to indicate |
| | | the packet is encrypted with the algorithm described by this |
| | | RTCP packet. The RTP payload being the application data |
| | | that is to be securely transmitted via RTP according to the |
| | | present invention. |
| Secure Hops | 8 | The number of hops across which security has been |
| | | requested. |
| Diffie-Hellman | 32 | The Diffie-Hellman transmitted key value (i.e., the “g” value |
| Key | | in the Diffe-Hellman discussion of the Terms and Definitions |
| | | section). |
| Diffie-Hellman | 32 | The Diffie-Hellman base value (i.e., the Diffie-Hellman |
| base | | parameter “m”). |
| Diffie-Hellman | 32 | The Diffie-Hellman prime value. (i.e., the “h1” or “h2” value |
| Prime | | in the Diffe-Hellman discussion of the Terms and Definitions |
| | | section) |
| Cypher Sequence | 32 | The sequence number of the first RTP packet that will be |
| Synchronization | | encrypted. This allows cipher algorithms to synchronize in |
| Parameter | | the presence of packet loss on the network. Without this |
| | | parameter, if the first encrypted packet was lost the |
| | | decrypting cypher would be out of synchronization with the |
| | | encrypting cipher. |

To establish secure RTP communications between endpoints 14 and 16, the RTP/RTCP network interface 24a communicates with an encryption controller 30a which, in turn, controls the activation, deactivation, and processing behavior of the encryption parameter generator 32a and the cypher 36a. In particular, the encryption controller 30a controls the cypher encryption generator 32a so that this generator can generate appropriate encryption parameter data (e.g., encryption/decryption keys) that can be supplied to the cypher 36a. That is, the generator 32a provides the cypher 36a with encryption parameter data to encrypt data received from the data input system(s) 40a, and/or to decrypt data received from RTP/RTCP network interface 24a. Additionally, the encryption controller 30a instructs the cypher 36a when to cease using the current encryption parameter data and change to using new encryption parameter data generated by the encryption parameter generator 32a.

Regarding cypher encryption generator 32a, an embodiment that corresponds with the RTCP APP packets of TABLE A is an implementation for Diffie-Hellman. Additionally note that for the RTCP APP packets structured as in TABLE A, the cypher 36a includes RC4 for encryption and/or decryption. However, it is within the scope of the invention that various other cryptographic techniques can also be used such as any symmetric block cipher such as: AES (Rijndael), RC2, RC5, RC6, MARS, Twofish, Serpent, IDEA, DES, Triple DES, Blowfish, TEA, SAFER+, GOST, CAST-128, CAST-256, Square, and Skipjack as one skilled in the art will understand. Additionally note that cypher 36a may encrypt data segments from the data input system(s) 40a, wherein these segments are of the length determined by the RTP payload format. Standardized RTP profiles and payload formats are defined in RFC1890, RTP Profile for Audio and Video Conferences with Minimal Control by H. Schulzrinne, GMD Fokus, January 1996 incorporated fully herein by reference. However, various lengths for such data segments may be used such as the length determined by the capabilities of the hardware implementing data input system(s) 40a.

The RTP/RTCP network interface 24a also communicates with data controller 44a for controlling whether data provided by the data input system(s) 40a is to be encrypted or not prior to being provided to the RTP/RTCP network interface 24a for transmitting on the network 20. Additionally, the data controller 44a provides the data output system(s) 48a with information indicative of whether to receive their input, e.g., from the RTP/RTCP network interface 24a, or from the cypher 36a, this depending upon whether such input must be decrypted prior to being supplied to the data output system(s). Note that the data controller 44a may be incorporated into one or more of the data input system(s) 40a and the data output system(s) 48a in which case the RTP/RTCP network interface may communicate directly with these input and output systems. Additionally, note the data input system(s) 40a may be one or more of systems for audio input, video input, text entry, and other types of input devices like machine sensors, and the data output system(s) 48a may be one or more of systems for audio output, video output, text readout, and other types of output mechanisms like graphical representations of data such as graphs.

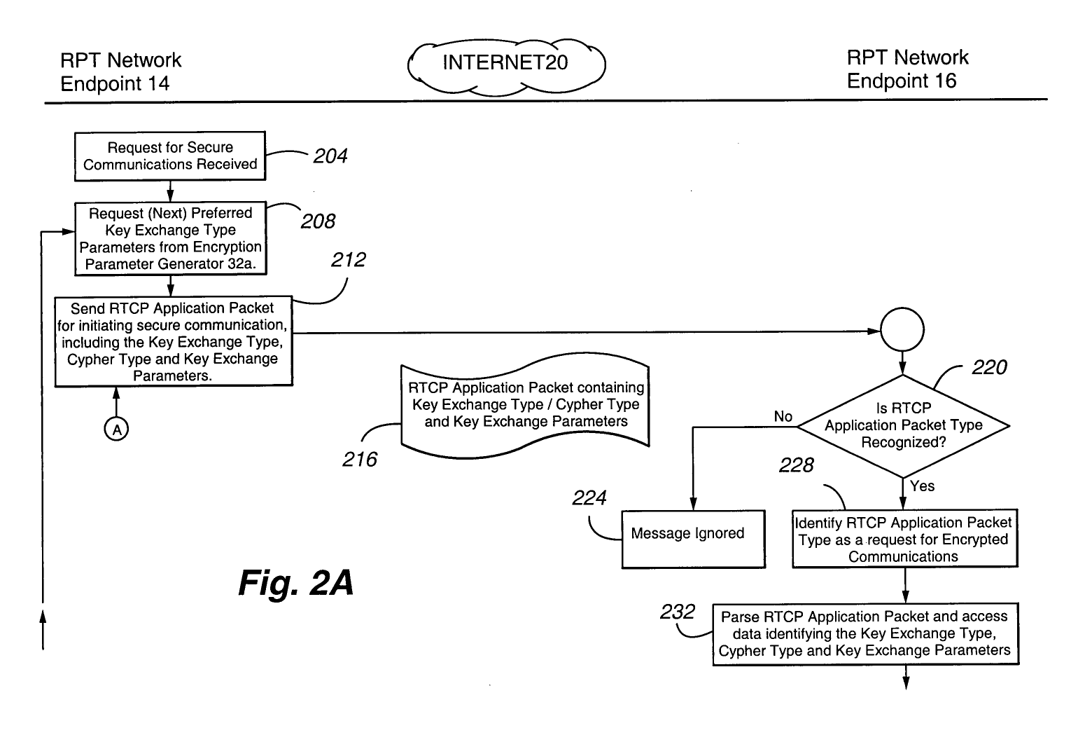

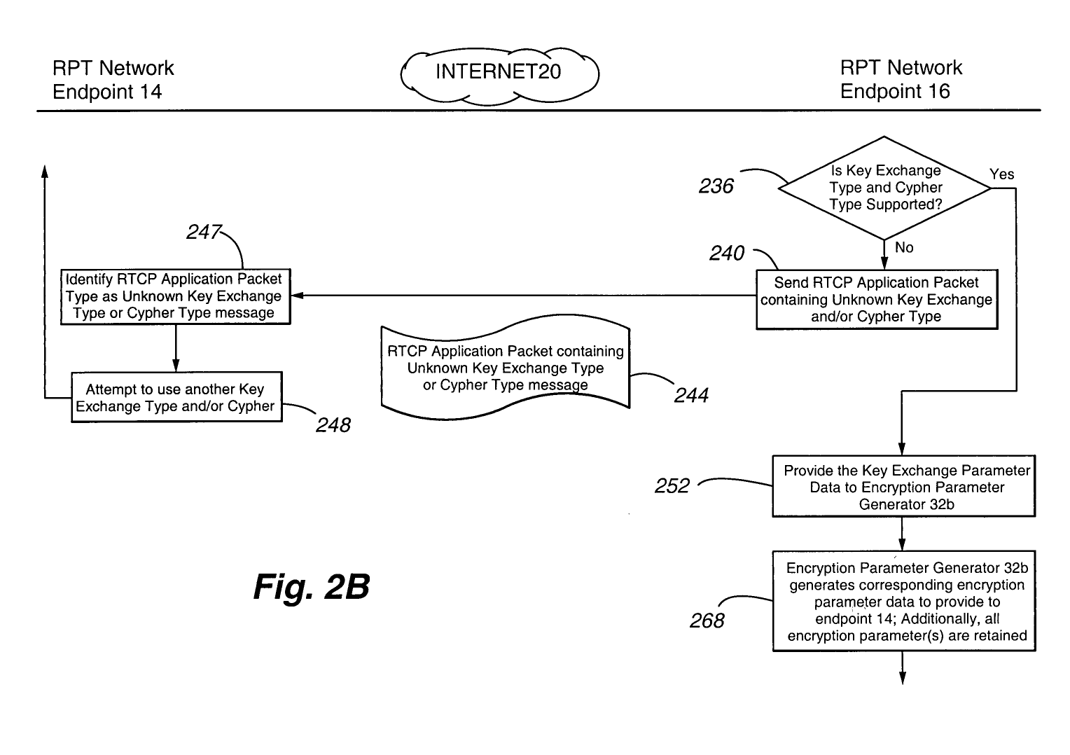

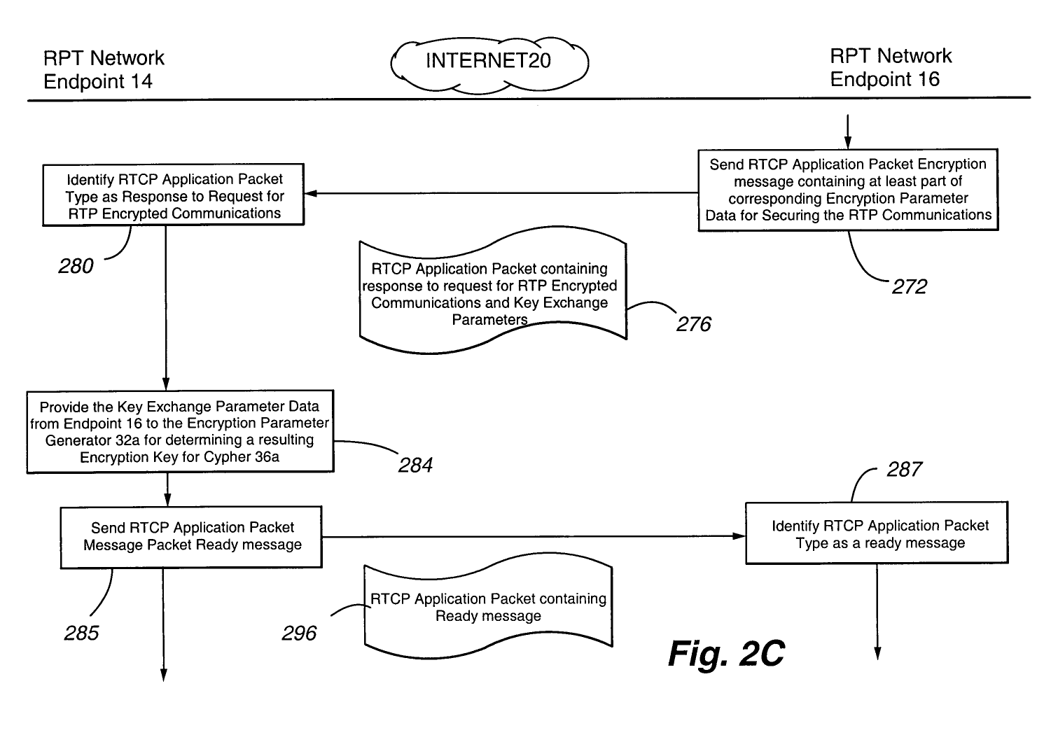

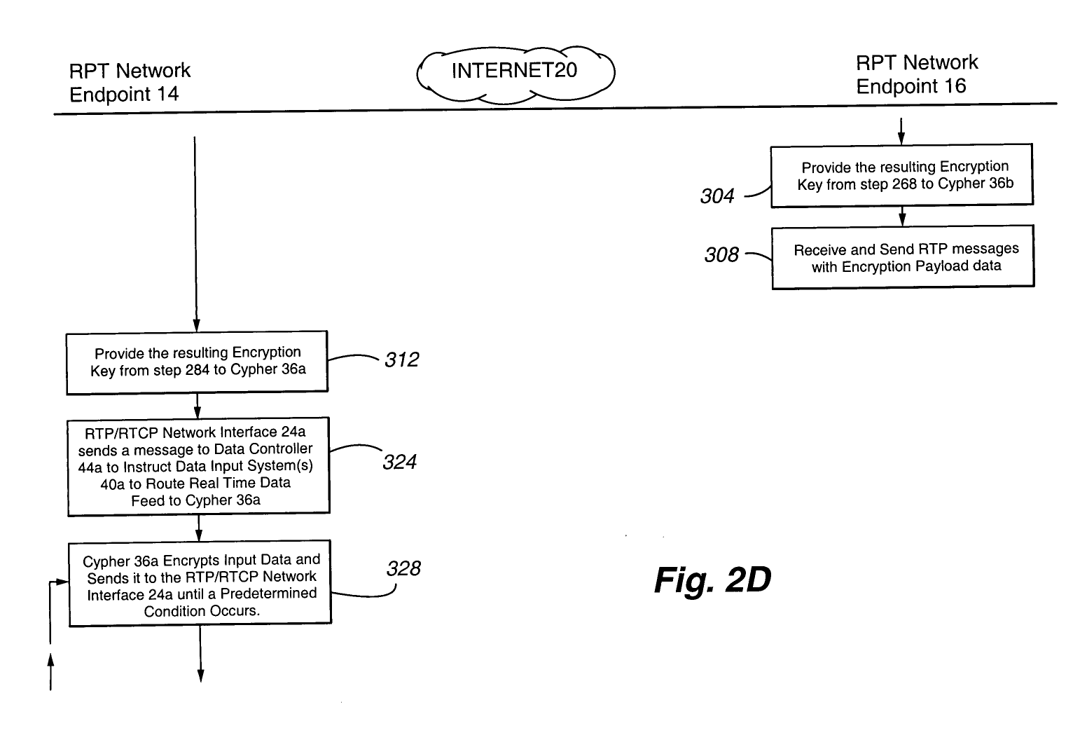

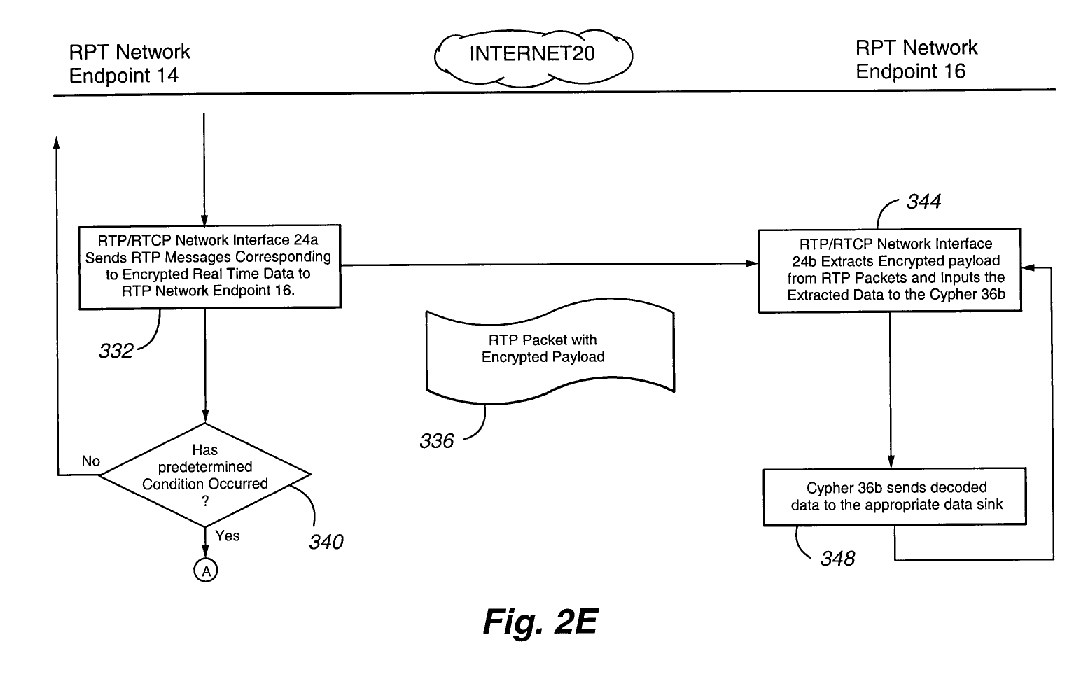

FIGS. 2A through 2C provide a flowchart of the steps performed by one embodiment of the secure communication system 10 (FIG. 1) of the present invention. Note that the steps on the left-side of these figures are performed at the endpoint 14 and the steps on the right-side are performed at the endpoint 16. Generally in the middle between the left-side steps and right-side steps are descriptions of the RTP and RTCP messages communicated between these endpoints. Note, however, that each of these message descriptions describe only the content of the message as it relates to the present invention. One skilled in the art of RTP and RTCP will recognize that additional information is likely to be included in such messages such as is indicated by the fields of the RTCP message illustrated in TABLE A above.

Commencing to describe the steps of FIGS. 2A-2C, it is assumed that endpoint 16 initiates a request for secure communications with endpoint 14. Accordingly, in step 204, RTP/RTCP network interface 24a receives, via network 20, an RTCP request from endpoint 16 for secure communications. The network interface 24a activates a parser 31a for parsing the RTCP request, wherein the parser parses this request according to the data structure representation illustrated in TABLE A (or a variation thereof when different encryption techniques are used than those illustrated in TABLE A). In response, step 208 is performed wherein a request from the RTP/RTCP network interface 24a is generated and provided to the cypher encryption parameter generator 32a (e.g., via the encryption controller 30a) for obtaining an initial set of encryption parameter data (for a particular key exchange type and cypher type specified by the encryption controller 30a). In one embodiment wherein Diffie-Hellman is used by the cypher encryption parameter generator 32a, the parameters g, m and h1 as described in the Definition and Terms section hereinabove are generated by the cypher encryption parameter generator 32a. In particular, the cypher encryption parameter generator 32a may generate these parameter values (and additionally e1 also described above) using conventional techniques known in the art.

Subsequently, in step 212, once the RTP/RTCP network interface 24a is provided with the generated parameter values (also denoted collectively as encryption parameter data), the interface 24a creates an RTCP data packet according to the data structure representation of TABLE A (or a variation thereof when different encryption techniques are used than those illustrated in TABLE A) having these parameters therein, and then transmits these this responsive RTCP packet as message 216. In step 220, the RTP/RTCP network interface 24b of endpoint 16 receives the message 216 and parses it using RTP/RTCP parser 31b. Subsequently, the interface 24b and/or the parser 31b determines whether the RTCP message 216 has an RTCP application packet of a type that is recognized by endpoint 16 (step 220); in particular, the network interface 24b inspects the “Packet Type” and/or the “SubType” fields shown in TABLE A above to make this determination. Presumably, since the endpoint 16 requested the secure network communications, this endpoint will recognize and have the ability to properly process such RTCP application packets. However, in the event that such RTCP application packets are not recognized as an RTCP packet for which endpoint 16 has a method for processing, then step 224 is performed wherein RTCP packet of message 216 is simply ignored.

Assuming that endpoint 16 recognizes the RTCP application packet, in step 228 the RTCP application packet is identified (by, e.g., the RTP/RTCP network interface 24b) as a packet for requesting encrypted communications with endpoint 14. Subsequently in step 232, the RTP/RTCP network interface 24b may activate the parser 31b to further parse the RTCP packet for obtaining the encryption parameter data (e.g., g, m and h1), as well as the key exchange type and the cypher type. Then in decision step 236, the RTP/RTCP network interface 24b (or alternatively, the encryption controller 30b) determines whether the encryption technique indicated by endpoint 14 (i.e., the key exchange type and the cypher type provided in the “algorithm” field of the RTCP data packet) is available for use at endpoint 16. Note that RTCP packet processing specific to a particular functionality, such as encryption, may be performed by one or more additional modules or methods, such as the encryption controller 30b, that are provided as an extension of the standardized RTP/RTCP functionality.

If endpoint 16 does not support the cryptographic technique identified for use by endpoint 14, then in step 240 the RTCP packet may be ignored without any further processing. Alternatively, a responsive message 244 may transmitted back to endpoint 14 by the RTP/RTCP network interface 24b, wherein the message indicates that the key exchange type and/or the cypher type is unknown (or unavailable) to the endpoint 16. Subsequently upon receiving the message 244 and identifying its contents (step 247), the RTP/RTCP network interface 24a may provide the encryption controller 30a, in step 248, with information indicating that the proposed key exchange type and/or the cypher type is unknown (or unavailable or unacceptable) to the endpoint 16. Thus, the encryption controller 30a can then select an alternative key exchange type and/or cypher type, and subsequently instruct the encryption parameter generator 32a to provide a set of corresponding encryption parameter data. Alternatively, it may be the case that the real time data that was intended to be transmitted to endpoint 16 will not be sent and possibly an alternative, less proprietary, version of the data will be sent instead, and additionally, the change to a less proprietary version may be logged by one of the data output systems 48a.

Assuming that the outcome to step 236 indicates that the endpoint 16 has available for use the encryption technique specified by the RTCP packet of message 216, then in step 252 the encryption parameter data received from the endpoint 14 is provided to cypher encryption parameter generator 32b.

In step 268 the encryption parameter generator 32b generates additional encryption parameter data (e.g., a public-private key pair) that is to be used in conjunction with the encryption parameter data received from endpoint 14. Additionally, the public key data of a public-private key pair is to be provided to the endpoint 14 (in step 272). Note that the encryption parameter generator 32b may use the encryption parameter data provided by endpoint 14 in determining the additional encryption parameter data. For example, assuming that Diffie-Hellman is used by the encryption parameter generator 32b, the numbers for h2 and e2 as described in the Definitions and Terms section above can be generated by the encryption parameter generator 32b using publicly available techniques known to those skilled in the art. Accordingly, h2 is to be supplied to the endpoint 14, and both h2 and e2 are stored for subsequently supplying to cypher 36b.

It is, however, within the scope of the present invention for either or both of encryption parameter generators 32a and 32b to use other encryption parameter data generation techniques than Diffie-Hellman. For example, the following techniques can be used (as one skilled in the art will appreciate):

(a) Buchmann-Williams Key Exchange Algorithm;

(b) KEA (Skipjack); and

(c) RSA Key Exchange.

Accordingly, in step 272, the RTP/RTCP network interface 24b is provided with the encryption parameter data to be transmitted to the endpoint 14, and the interface 24b generates a network 20 message 276 having an RTCP packet therein with at least the encryption parameter data needed by the endpoint 14 for encrypting and/or decrypting data communicated with the endpoint 16 via the network 20. In step 280, the RTP/RTCP network interface 24a identifies the RTCP packet as a response for commencing RTP encrypted communications, and in step 284 the encryption parameter data received from the endpoint 16 is provided to the encryption parameter generator 32a, wherein a resulting one or more encryption parameters are derived for providing to the cypher 36a. In particular, the following resulting parameters may be provided to the cypher 36a (depending upon the encryption technique to be used):

(a) AES (Rijndael):

Input to a cypher of this type is a key of 128, 192, or 256 bits in size;

(b) RC2:

Input to a cypher of this type are a key of variable size and an additional string called a salt 40 to 88 bits long;

(c) RC5:

Input to a cypher of this type are a key of 0 to 2040 bits in size and the number of rounds as a number between 0 and 255 inclusive

(d) RC6:

Input to a cypher of this type are a key of 0 to 2040 bits in size and the number of rounds as a number between 0 and 255 inclusive;

(e) MARS:

Input to a cypher of this type is a key of 128, 192, or 256 bits in size;

(f) Twofish:

Input to a cypher of this type is a key of up to 256 bits in size;

(g) Serpent:

Input to a cypher of this type is a key of 128, 192, or 256 bits in size;

(h) DES:

Input to a cypher of this type is a key of 56 bits in size;

(i) Triple DES:

Input to a cypher of this type are 3 keys of 56 bits in size;

(j) Blowfish:

Input to a cypher of this type is a key of 32 to 448 bits in size;

(k) SAFER+:

Input to a cypher of this type is a key of 128, 192, or 256 bits in size;

(1) GOST:

Input to a cypher of this type is a key of 256 bits in size;

(m) CAST-128:

Input to a cypher of this type is a key of 128 bits in size;

(n) CAST-256:

Input to a cypher of this type is a key of 256 bits in size;

(o) Square:

Input to a cypher of this type is a key of 128 bits in size;

(p) Skipjack:

Input to a cypher of this type is a key of 80 bits in size.

In step 285, assuming that the encryption parameter generator 32a is successful at generating a resulting encryption key for cypher 36a, the encryption controller 30a is provided with feedback from the encryption parameter generator 32a indicating successful generation of an encryption key for cypher 36a. As a consequence, the encryption controller 30a communicates with the RTP/RTCP network interface 24a resulting in an RTCP application packet message (296) being transmitted to the endpoint 16 indicating that the endpoint 14 is ready to commence communicating with the endpoint 16 using encrypted RTC communications.

In an alternative embodiment, if the encryption parameter generator 32a is not successful and the resulting encryption parameters can not be determined or are unacceptable to cypher 36a (e.g., due to one of the endpoints 14 and 16 being mis-configured, or the endpoints having different versions of firmware embodying the present invention such that different encryption schemes are supported), then the RTP/RTCP network interface 24a is instructed, via a message from the encryption control 30a, to construct an RTCP packet for transmission in message (not shown) to endpoint 16, wherein this RTCP packet indicates that a failure has occurred in initializing the encryption capabilities of endpoint 14 and that the endpoint 16 should try again (note this corresponds to a predetermined value in the “SubType” field illustrated in TABLE A).

In any event, once the resulting encryption parameter(s) are determined and acceptable, then the message 296 is generated having an RTCP packet indicating that endpoint 14 is ready for secure communications.

Assuming that endpoint 16 properly identifies RTCP packet from endpoint 14 (step 287), secure communications can commence. Accordingly, step 304 is performed wherein the encryption controller 30b instructs the encryption parameter generator 32b to provide the retained encryption parameter data to the cypher 36b. Then in step 308, the RTP/RTCP network interface 24b waits for RTP messages from endpoint 14 having encrypted application data therein, or sends messages having RTP data packets with encrypted application data therein to be decrypted by cypher 36a.

Returning now to endpoint 14, in addition to sending the message 296, step 312 is performed wherein the encryption controller 30a instructs the encryption parameter generator 32a to provide the resulting encryption parameter(s) determined in step 284 to cypher 36a for encrypting and decrypting data supplied thereto. Then in step 324, the RTP/RTCP network interface 24a (or alternatively the encryption controller 30a) sends a message to the data controller 44a directing it to instruct the data input system(s) 40a to route their real time data, intended for endpoint 16, to the cypher 36a to be encrypted. Note that there are various other embodiments wherein step 324 is performed differently. In particular, the data input system(s) 40a may provide their real time data directly to the RTP/RTCP network interface 24a wherein this interface determines which network 20 endpoint the data to be provided and whether data the is to be encrypted. Accordingly, the RTP/RTCP network interface 24a may communicate with the encryption controller 30a for routing the data to the cypher 36a when it determines that the data is to be transmitted to the endpoint 16.

Subsequently upon receiving data to be encrypted (and optionally information indicating the cryptographic technique to use, and likely the encryption control parameters), the cypher 36a (in step 328) encrypts the input data and sends the resulting encrypted data to the RTP/RTCP network interface 24a for transmitting to the endpoint 16. Note that the cypher 36a continues receive, encrypt (or decrypt), and output corresponding encrypted data until some predetermined condition occurs such as: (a) a message from endpoint 16 to terminate the secure communication session, (b) there is no more data to send, or (c) there is a failure in the network 20 that causes the communication session to be terminated. Additionally, such a predetermined condition may occur due to the need to change the encryption parameter data to thereby provide greater assurance that the communications between the endpoints 14 and 16 will not be intercepted and deciphered by an unauthorized network endpoint. In particular, it is believed that the encryption parameter data (i.e., encryption parameter data) should be replaced with different encryption control parameter data approximately every 5 to 60 minutes, wherein this time interval may be configurable so that the level of security can be adjusted according the security policies. Note that in an alternative embodiment, the predetermined condition may occur at the endpoint 16, in which case, e.g., cypher 36b may cease encrypting and/or decrypting, and may change encryption parameter data and the subsequently generated encryption keys.

With each amount of encrypted data supplied to the RTP/RTCP network interface 24a, in step 332, this interface constructs a message 336 having an RTP data packet therein with the encrypted data (i.e., the “payload”) and transmits the message to its corresponding network 20 destination, e.g., endpoint 16. Subsequently in step 340 a determination is made by one of the RTP/RTCP network interface 24a, or an encryption controller 30a as to whether one of the predetermined conditions (or perhaps more precisely, predetermined condition types) has occurred. If not, then step 328 is again performed. Alternatively, assuming the predetermined condition is to obtain new encryption parameter data, then step 212 is performed. For an occurrence of one of the other predetermined conditions, the entire process terminates (this is not shown in the FIGS. 2A-2C).

Retuning now to the steps performed by the endpoint 16, when the RTP/RTCP network interface 24b receives the message(s) 336, step 344 is performed wherein the interface 24b extracts the encrypted data from the RTP data packet(s) and inputs the extracted data to the cypher 36b for decrypting. Subsequently, in step 348 the decoded or decrypted data output by the cypher 36b is output to an appropriate data output system 48b.

It is important to note that, given the above description, it is well within one of ordinary skill in the art to provide various alternative embodiments to the flowchart of FIGS. 2. For example, such alternative embodiments can be provided wherein: (a) the endpoint 14 initiates a request for secure communications with endpoint 16, (b) the endpoint 16 determines whether one of the predetermined condition types has occurred (e.g., step 340) for, e.g., terminating or reconfiguring the encryption/decryption cyphers a secure communications session, or (c) the endpoint 16 transmitting one or more RTP data packets to the endpoint 14, e.g., interspersed with (or alternatively instead of) the RTP data packets sent from the endpoint 14 to the endpoint 16. Accordingly, in such alternative embodiments, some of the steps described in FIGS. 2A-2C may be performed by the other of the endpoints 14 and 16 than the one identified in FIGS. 2. For example, an alternative to step 204 could be a transmission, via network 20, by the endpoint 14 to the endpoint 16 for requesting secure communications therebetween. In such a case, the request in step 208 by the endpoint 14 for encryption parameter data from cypher encryption generator 32a in response to step 204 could instead have been provided by the endpoint 16.

The foregoing discussion of the invention has been presented for purposes of illustration and description. Further, the description is not intended to limit the invention to the form disclosed herein. Consequently, variation and modification commiserate with the above teachings, within the skill and knowledge of the relevant art, are within the scope of the present invention. The embodiment described hereinabove is further intended to explain the best mode presently known of practicing the invention and to enable others skilled in the art to utilize the invention as such, or in other embodiments, and with the various modifications required by their particular application or uses of the invention.

What is claimed is:

1. A method for providing secure communications on a network having unsecure communications thereon, comprising:
generating a first message, at a first network endpoint, according to a predetermined control protocol for controlling real time or nearly so communications on the network, wherein said first message includes a request for encrypted real time or nearly so communications in a predetermined real time protocol for real time or nearly so communications between the first network endpoint and a second network endpoint;
sending said first message to the second network endpoint, via the network, in the control protocol;
at the second network endpoint, parsing said first message according to said control protocol;
determining whether said request for encrypted real time or nearly so communications between said first and second network endpoints can be satisfied at the second network endpoint;
when said request can be satisfied at the second network endpoint, the following steps (a)-(c) are performed:
(a) receiving, at the first network endpoint from the second network endpoint, a second message in said control protocol;
wherein said second message provides encryption related data for operatively configuring a first cypher accessed by the first network endpoint for encrypting data input to the first network endpoint, and wherein there is a second cypher at the second network endpoint operatively configured to decrypt encrypted information communicated on the network in the real time protocol from the first cypher, wherein the encrypted information corresponds in content to the data input to the first cypher, and wherein said second cypher is operatively configured using encryption related data received from the first network endpoint;
(b) until a predetermined condition occurs, performing the following steps (b 1) and (b2):
(b1) encrypting with said first cypher, information that is input to the first network endpoint;
(b2) transmitting on the network, from the first network endpoint, an encrypted version, of said information, output by said first cypher, wherein said encrypted version is transmitted in the real time protocol, wherein said encrypted version is decrypted by said second cypher when said encrypted version is received by said second endpoint;
(c) upon said predetermined condition occurring, generating a third message, at one of the first and second network endpoints, according to the control protocol, wherein said third message includes encryption related data for reconfiguring at least one of said first and second ciphers for decrypting the real time data provided by the first network endpoint differently.

2. The method of claim 1, wherein said predetermined condition includes information for changing encryption control parameters for one said first and second ciphers.

3. The method of claim 2, wherein said information for changing includes an elapsed time between changes of said encryption control parameters.

4. The method of claim 1, wherein said predetermined control protocol is RTCP and said real time protocol is RTP.

5. The method of claim 1, wherein at least one of said first and second messages includes at least some of: (i) a version identification of said real time communications protocol, (ii) an identifier for designating whether the message requests initiation of encrypted communications between the first and second endpoints, (iii) an identifier for designating a particular technique for at least one of encrypting and decrypting, (iv) an identifier for designating that a communication in said real time protocol is encrypted, and (v) an encryption key value to be used in one of encrypting and decrypting a communication in said real time protocol.

6. The method of claim 1, wherein the network includes at least portion of the Internet.

7. The method of claim 1, wherein said encryption related data includes values for one or more of: (i) identifying said first cypher as a cypher to be used in providing secure communications between said first and second endpoints, (ii) identifying a key exchange type, and (iii) generating encryption keys.

8. The method of claim 1, wherein from an input of the information to the first network endpoint to an output of the information from the second network endpoint, the information is real time or nearly so.

9. The method of claim 1 further including communicating said information on the network as part of a performance providing one of: voice over IP and a network broadcast of a presentation.

10. The method of claim 1, wherein at least one of said first and second ciphers encrypts information for secure communications between said first and second network endpoints using one of: AES, RC2, RC4, RC5, RC6, MARS, Twofish, Serpent, DES, Triple DES, Blowfish, SAFER+, GOST, CAST-128, CAST-256, Square, and Skipjack.

11. The method of claim 1, further includes a step of selecting said first cypher from a plurality of cyphers.

12. An apparatus for providing encrypted communications on a network, comprising:
an interface to a communications network for at least one of transmitting and receiving RTP and RTCP data packets via the network;
one or more cyphers for at least one of: encrypting information to be transmitted via said interface and the network, and decrypting information received via said interface and the network;
an encryption parameter generator for generating encryption parameter data to be used by: (a) a first of said one or more cyphers, and (b) an additional cypher, wherein at least a portion of said encryption parameter data is communicated to said additional cypher via said interface and the network;
a parser for parsing RTCP and RTP data packets communicated on the network so that second encryption parameter data is obtained from one or more of said RTCP data packets;
wherein after being parsed, said second encryption parameter data is input to said encryption generator for generating encryption key data, wherein at least one value of said encryption key data is transmitted, via said interface and the network, to said additional cypher for use in one of encrypting, and at least one value is used to configure said first cypher for one of encrypting and decrypting said RTP data packets;
wherein for obtaining said second encryption parameter data, said RTCP data packets includes at least some of: (i) an identification of a version of RTP that is available at a network site that transmits said RTCP data packets, (ii) an identifier for designating whether a request for initiation of encrypted communications is being provided, (iii) an identifier for designating a particular technique for at least one of encrypting and decrypting real time data provided in said RTP data packets, (iv) an identifier for designating that a communication in RTP is encrypted, and (v) said second encryption parameter data.

13. The apparatus of claim 12 further including an encryption controller for determining when said first cypher is to use different encryption parameter data generated by said encryption parameter generator.

14. The apparatus of claim 12, wherein each of said one or more cyphers use at least one of the following encryption techniques: AES, RC2, RC4, RC5, RC6, MARS, Twofish, Serpent, DES, Triple DES, Blowfish, SAFER+, GOST, CAST-128, CAST-256, Square, and Skipjack.

15. The apparatus of claim 12, wherein said interface generates IP communications for transmission on the network.

16. The apparatus of claim 12, wherein said encryption parameter generator uses one or more of the following techniques:
(a) Diffie-Hellman;
(b) Buchmann-Williams Key Exchange Algorithm;
(c) KEA (Skipjack); and
(d) RSA Key Exchange.

17. A method for providing secure communications on a network having unsecure communications thereon, comprising:
receiving, from a first network endpoint, a first message at a second network endpoint, said first message represented in a predetermined communications control protocol for controlling real time or nearly so communications on the network that are represented in a predetermined real time protocol for real time or nearly so communications;
wherein said first message includes a request for encrypting real time or nearly so communications in said real time protocol between the first network endpoint and the second network endpoint;
parsing said first message according to said control protocol;
transmitting, to the first network endpoint, a second message in said control protocol;
wherein said second message provides encryption parameter data for operatively configuring a first cypher accessed by the first network endpoint for encrypting data input to the first network endpoint;
operatively configuring a second cypher accessed by the second network endpoint for one or more of (a1) and (a2):
(a1) decrypting encrypted information communicated on the network in the real time protocol from the first network endpoint, wherein the encrypted information corresponds in content to data input to the first network endpoint, and wherein said second cypher is operatively configured using encryption related data received from the first network endpoint;
(a2) encrypting second information input to said second network endpoint for transmitting an encrypted version of the second information to said first network endpoint in the real time protocol;
wherein at least one of: (i) from an input of the information to the first network endpoint to an output of the information from the second network endpoint, the information is real time or nearly so, and (ii) from an input of the second information to the second network endpoint to an output of the second information from the first network endpoint, the second information is real time or nearly so.

18. The method of claim 17, further including a step of selecting said second cipher according to encryption determining information received from the first endpoint.

19. The method of claim 17, further including, when a predetermined condition occurs, a step of receiving a third message, at the second network endpoint, in the control protocol, wherein said third message includes encryption related data for reconfiguring said second cipher for decrypting the encrypted information provided by the first network endpoint differently.

20. The method of claim 17, further including, when a predetermined condition occurs, a step of transmitting a third message, from the second network endpoint, in the control protocol, wherein said third message includes encryption related data for reconfiguring said first cipher for decrypting the encrypted second information provided by the second network endpoint differently.

21. The method of claim 20, wherein said predetermined condition includes an elapsed time between changes of said encryption control parameters.

22. The method of claim 17, wherein said predetermined control protocol is RTCP and said real time protocol is RTP.

23. The method of claim 17, wherein at least one of said first and second messages includes at least some of: (i) a version identification of said real time communications protocol, (ii) an identifier for designating whether the message requests initiation of encrypted communications between the first and second network endpoints, (iii) an identifier for designating a particular technique for at least one of encrypting and decrypting, (iv) an identifier for designating that a communication in said real time protocol is encrypted, and (v) an encryption key value to be used in one of encrypting and decrypting a communication in said real time protocol.

24. The method of claim 17, wherein the network includes at least portion of the Internet.

25. The method of claim 17, wherein said encryption related data includes values for one or more of: (i) identifying said first cypher as a cypher to be used in providing secure communications between said first and second endpoints, (ii) identifying a key exchange type, and (iii) generating encryption keys.

26. The method of claim 17 further including communicating at least one of said information and said second information as part of a performance providing one of: voice over IP and a network broadcast of a presentation.

27. The method of claim 17, wherein at least one of said first and second ciphers encrypts information for secure communications between said first and second network endpoints using one of: AES, RC2, RC4, RC5, RC6, MARS, Twofish, Serpent, DES, Triple DES, Blowfish, SAFER+, GOST, CAST-128, CAST-256, Square, and Skipjack.

28. The method of claim 17, further includes a step of selecting said first cypher from a plurality of cyphers.
